(19) United States
(12) Patent Application Publication
(10) Pub. No.: US 2013/0037672 A1
(43) Pub. Date: Feb. 14, 2013

(54) Twist Tie Hat Hook Headrest Hanger

(71) Applicant: Roy C. Sanchez, Las Vegas, NV (US)

(72) Inventor: Roy C. Sanchez, Las Vegas, NV (US)

(21) Appl. No.: 13/208,112

(22) Filed: Aug. 11, 2011

(51) Int. Cl. F16B 45/00; B60R 7/00

(52) U.S. Cl. 248/303; 224/275

(57) ABSTRACT

A headrest hat hook comprised of a twist tie and hat hook that is mounted on the side of a headrest designed to be a hat hanger. In a preferred embodiment an industrial twist tie or bendable wire material attached with a double hat hook that holds its shape and becomes the support post for the hat hook when twisted and bent around the headrest post. The wire is wrapped in rubber foam to give it grip when tied around the headrest post. The hat hook is attached to each end of the twist tie where it can be mounted on the side of the headrest. The bendable material is shape to give a right angle base support for the hat hook. The back of hat hook mount has an adhesive backside that can be attached to the side of the headrest. The hat hook can be adjusted and rotated so it points vertical no matter how the mount is placed on the side. The twist tie hat hook is designed to mount on any automobile headrest to become a hat hanger.

### FIELD OF THE INVENTION

The invention relates to an automobile headrest hanger in particularly a hat hanger that is mounted on the side of the headrest and allows any hat to be hang inside the vehicle.

### BACKGROUND OF THE INVENTION

Many people wear hats when they travel, but have no place to store their hats inside the automobile. Some people place their hats on the seats and it gets in the way when passengers want to sit down. The present invention relates to headrest hanger designed to support on an automobile headrest seat. First there is a need for a hat hook on the side of the headrest so it is easy to reach and convenient to hang the hat. Second a headrest hat hook needs to be flexible and adjustable so it can be adapted to any types of vehicle headrest. Third it can hold many hats and doesn't get in the way of passenger. The present invention is distinguish over other headrest hanger because it is mounted on the side of the headrest beside the shoulder. The stand can be twisted and tied down on the post and the shape can be bent to allow the hooks to stand up.

### SUMMARY OF THE INVENTION

The invention is a twist tie hat hook design to mount on the side and shoulder of any automobile headrest. The twist tie hat hook provides a place to hang hats from the side of the headrest. The preferred embodiment is an industrial twist tie with a double prong hat hook attached on both ends. The twist tie hat hook is tied down around the post of the headrest to secure it down.

The advantage of the present invention is the bendable twist tie stand can be shaped to hold the hat hook up and acts as the support beam to hold the weight of the hats. The twist tie is wrapped around the post of the headrest and can be bent upwards so the double hat hook can point upward. The twist tie hat hook has a flexible shape and can be configure so it can adapt to any types of automobile headrest. The backside of the hat hook has an adhesive mount so it can be securely mounted on the side of the headrest. The hat hook can be adjusted to rotate to any angle so it always faces up even if the mount is in a diagonal angle. The object of the present invention is to provide place to hang hats on the side of the headrest or shoulder of the seat.

### BRIEF DESCRIPTION OF THE DRAWINGS

FIG. 1 is a perspective view of the twist tie hat hook.

FIG. 2 is a perspective view of the twist tie hat hook wrapped around the headrest post of a vehicle seat.

FIG. 3 is a perspective view of twist tie hat hook with that is bent straight up to form the vertical post.

FIG. 4 displays a hat hook with a stiff plastic arm that has a right angle vertical stand to hold that hat hook up in the air.

### DESCRIPTION OF THE PREFERRED EMBODIMENT

The preferred embodiment is a bendable twist tie with hat hooks mounted on both ends of the industrial strength twist tie. The twist tie hat hook is a hanger for hats and can be used to tie around a car headrest post rail. The bendable metal is covered with soft foam rubber padding and the bendable metal can be shaped to create the support stand. The twist tie hat hook is mounted on the side of the headrest or shoulder providing a hat hanger on the side of the seat. The twist tie hat hook is wrapped around the post of the headrest and tied down for a secure hold. The twist tie hat hook can be bent to give a right degree angle so the hat hook is standing straight up. The industrial strength of the bendable metal holds and keeps its shape to hold the weight of the hats on the hook.

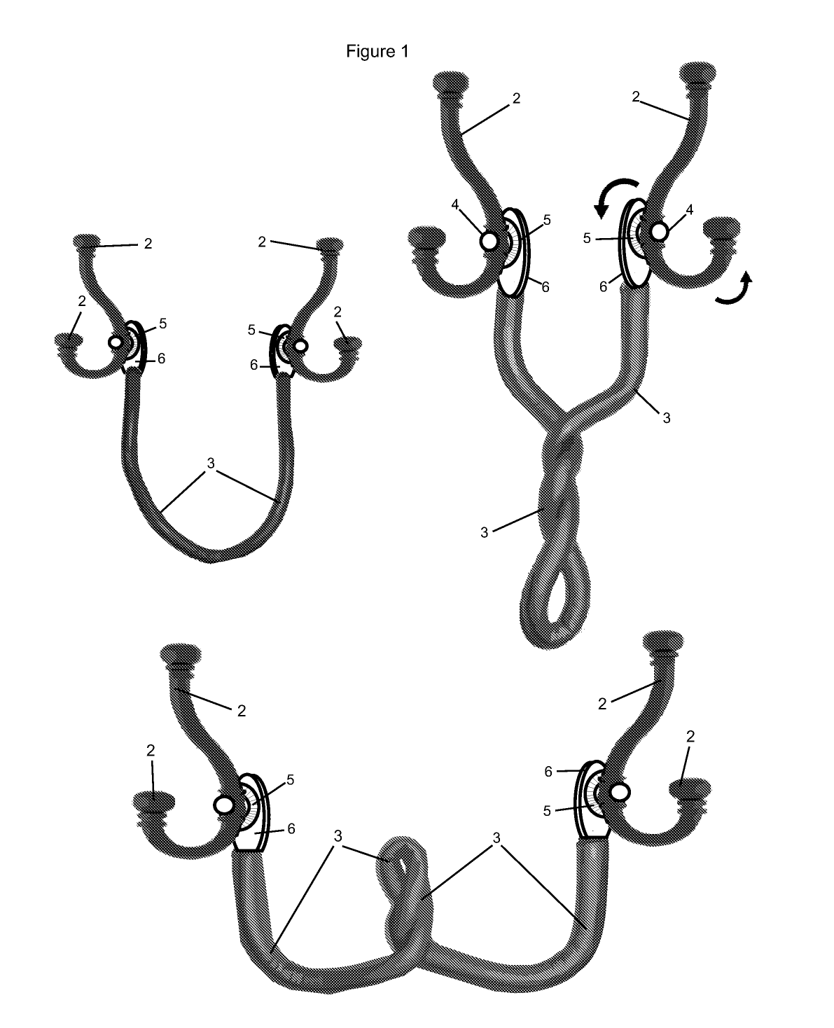

FIG. 1 illustrates a double hat hook 2 with a twisted wire material 3. The bendable wire material is wrapped in rubber foam 3 that acts like a grip when tied around a headrest post. The bendable twist tie 3 can hold a shape to form a vertical post for the hat hook 2. The hat hook has a pivot joint 4 that can rotate 5 and adjust in any direction so the hook is always vertical. The wall mount 6 has an adhesive back that can be mounted on the side of the headrest.

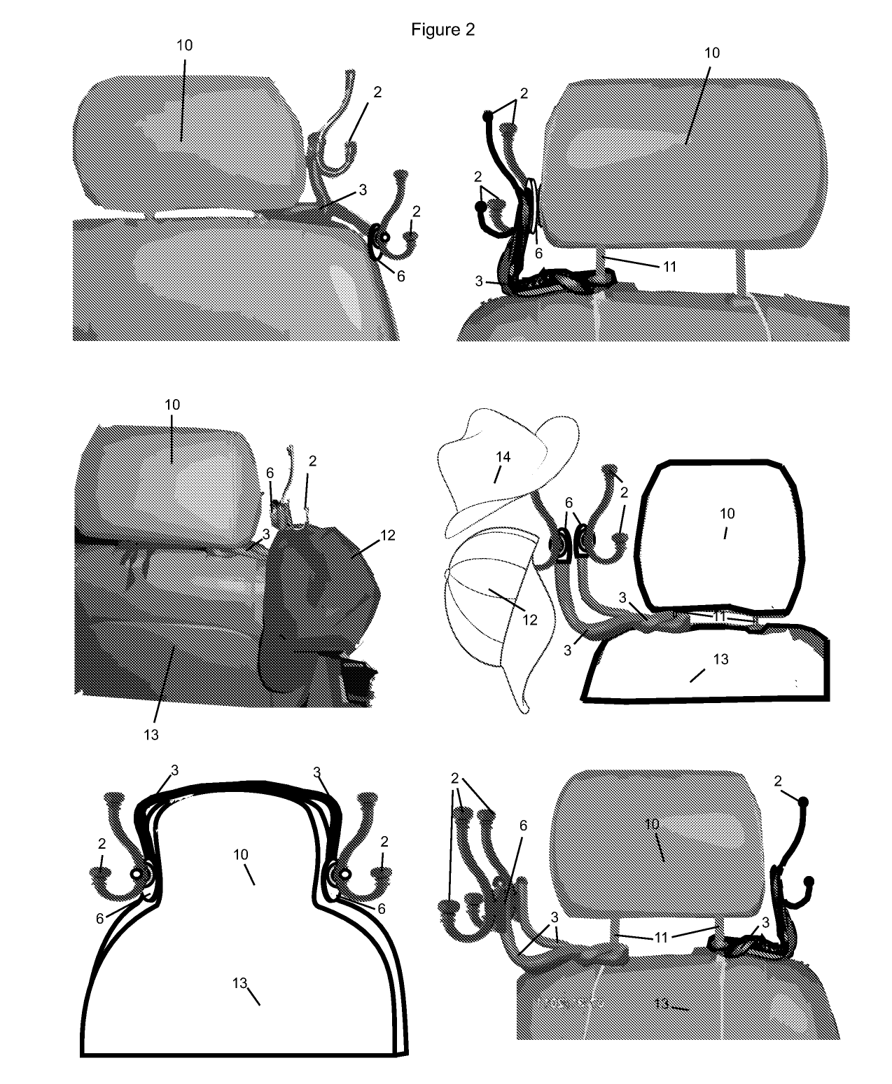

FIG. 2 illustrates the twist tie hat hook with many different configurations mounted on the side of an automobile headrest 10 seat. The mount of the hook 6 is placed on the side of the headrest 10. The twist tie 3 is twisted around the post 11 of the headrest 10. The twist tie 3 sits on the shoulder of the seat 13 for support. The twist tie 3 is bent vertical to act as the support post for the hat hook. The ends of the hat hooks can mount 6 against the side of the headrest or it can be separated so the other hat hook is on the shoulder of the seat 13. For vehicle seats that don't have a post to tie around the twist tie hat hook can be placed on top of the headrest 10. The adhesive mount 6 can mount on the side of the headrest 10 while the twist tie 3 acts like a bridge span support on top of the headrest 10.

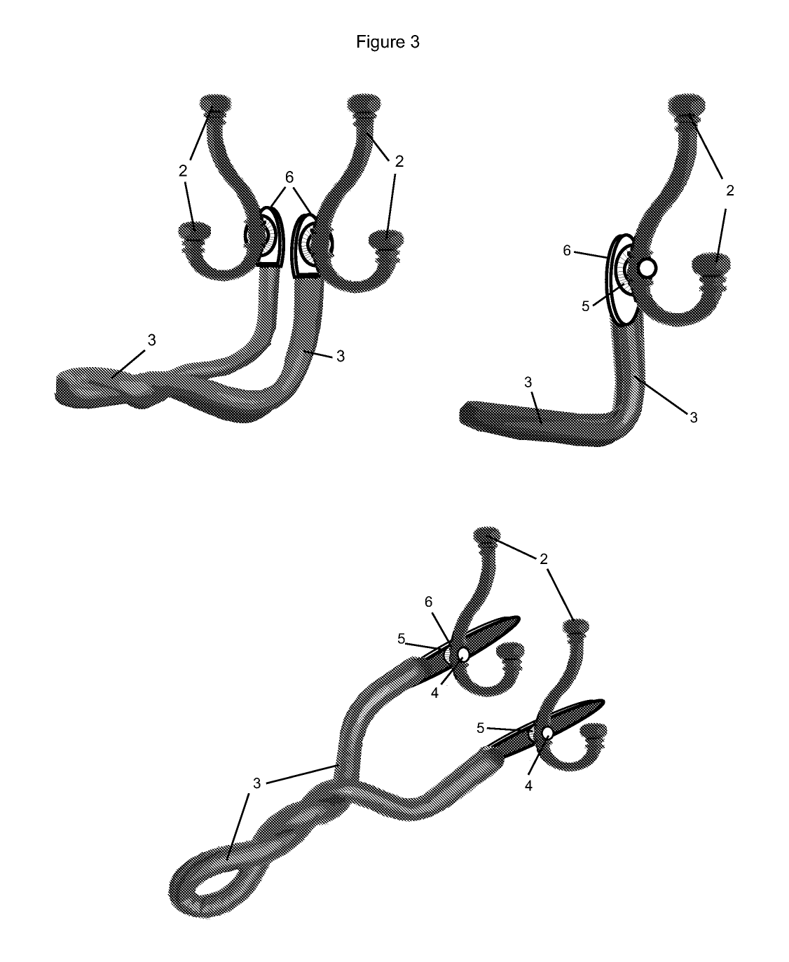

FIG. 3 is a close up of the double hat hook 2. The plastic mount 6 has a adhesive double side tape 7 on the backside of the mount 6. The pivot joint 4 allows the hooks to be adjusted and it can rotate 5 in any direction so the double hook 2 is always pointing vertical up. The bent arm forms a right angle to stand the vertical post up in the air.

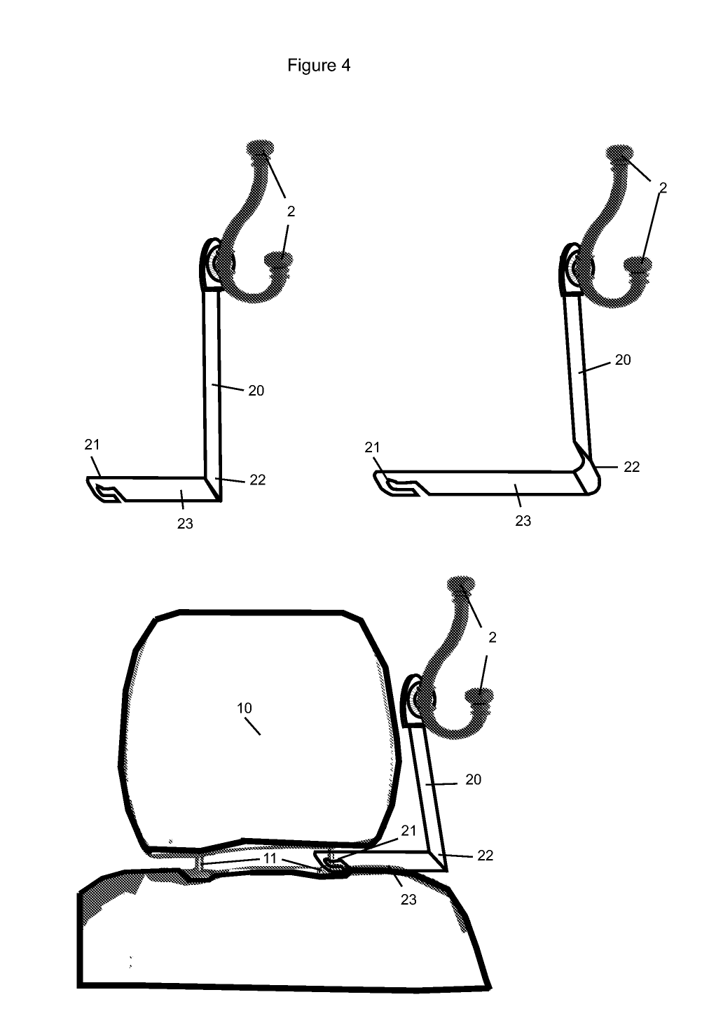

FIG. 4 illustrates a hat hook 2 with a stiff plastic material arm 23 that extends to a right angle elbow 22 and a vertical post 20 that stands the double hat hook 2 on the side of the headrest 10. The headrest hat hook 2 has a stiff plastic material arm 23 that has a hook 21 to attach itself to the headrest post 11. The plastic arm 23 with the right angle elbow corner 22 and the vertical post 20 is the support stand base for the hat hook 2 to mount onto. The arm stand 20, 21, 22, 23 stiff plastic material holds the hat hook 2 up in the air and pushes the hat hook 2 up against the side of the headrest 10 to keep it in place.

The twist tie hat hook can be adapted to any size and shape of hooks and can have a stiff plastic right angle vertical arm that forms the base stand for stronger support. The twist tie hat hook can be shaped, formed, and molded to always stand up straight in the air on the side of the headrest with its right angle plastic arm stand base. The twist tie hat hook can hang and hold any types of hats, coats, purse, and garments. The twist tie hat hook has a safety configuration in case of a car accident an impact force allows the plastic hooks to shatter to avoid piercing the passenger's body. The hat hang twist tie hat hook is design for easy installation on the side headrest and shoulder of any automobile seats providing a secure place to hang hats.

What is claimed:

1. A twist tie with double hat hooks mounted on each end of a twist tie wire use to hang hats.

2. The twist tie hat hook for claim 1 design to twist and tie around the headrest post to become a hat hanger.

3. A double hat hook attached with an industrial strength twist tie wire or bendable wire that holds its shape making a support stand.

4. The twist tie hat hook for claim 3 that with an adhesive mount on the backside that can be attached to the side of the headrest.

5. The twist tie hat hook for claim 3 that can rotate so it will point straight up no matter if the mount is at a diagonal angle.

6. A hat hook with a stiff plastic material arm with a right angle vertical post that can attach around a headrest post.

7. The hat hook for claim 6 with a vertical post arm that stands up on the side of the headrest made with a hard plastic material.

8. The twist tie hat hook for claim 1 that can be mounted on the side of any automobile headrest or on the shoulder of the seat providing a place to hang the passengers hats.

9. The twist tie hat hook for claim 1 that can be twisted and tie around the post of a headrest and bent to give a right angle to stand up the hat hook.

10. The twist tie hat hook for claim 1 that can be placed over the top of the headrest and mount on the side if there are no post available to tie down to.

11. The hat hook with a vertical post arm for claim 6 that attaches to the headrest post and the stiff plastic material with the right angle corner acts like an elbow support that pushes up against the side of the headrest and holds the hat hook vertically up in the air.
